(19) United States
(12) Patent Application Publication
(10) Pub. No.: US 2016/0370545 A1
(43) Pub. Date: Dec. 22, 2016

(54) SLEEVE FOR AN OPTICAL FIBER CONNECTOR

(71) Applicants: Amphenol Fiber Optic Technology (Shenzhen), Shenzhen City (CN); Gloriole Electroptic Technology Corp., Kaohsiung City (TW); Shen Zhen Wonderwin Technology Co., Ltd., Shen Zhen City (CN)

(72) Inventors: Bo-Lin JIANG, Shenzhen City (CN); Song-Sheng LI, Shenzhen City (CN); Min CHEN, Shenzhen City (CN); Chia-Hua WU, Kaohsiung City (TW); Jim LIN, Kaohsiung City (TW)

(21) Appl. No.: 15/069,024

(22) Filed: Mar. 14, 2016

(30) Foreign Application Priority Data
Jun. 18, 2015 (TW) 104209869

(51) Int. Cl. G02B 6/38

(52) U.S. Cl. CPC G02B 6/387; G02B 6/3887; G02B 6/3893

(57) ABSTRACT

A sleeve is adapted for a casing of an optical fiber. The casing has a projection and spaced-apart first and second protrusions. The sleeve includes a limiting unit, a first abutment structure, a second abutment structure and a grip unit. The limiting unit includes two clamping walls for clamping the casing and for abutting against the second protrusion of the casing. The first abutment structure is on the limiting unit for abutting against the projection of the casing. The second abutment structure is on the limiting unit for abutting against the first protrusion 35 of the casing. The grip unit extends from the limiting unit and is movable for driving the limiting unit to move the casing.

### CROSS-REFERENCE TO RELATED APPLICATION

This application claims priority to Taiwanese Application No. 104209869, filed on Jun. 18, 2015.

### FIELD

The disclosure relates to a connector sleeve, and more particularly to a sleeve for an optical fiber connector.

### BACKGROUND

Referring to FIG. 1, a conventional optical fiber connector 1 generally includes a connector body 11 and an optical fiber cable 12 connected to and extending away from the connector body 11. The optical fiber cable 12 has gradually replaced the conventional copper wire to be used in data transmission devices due to its small size, fast transmission speed, low attenuation, and being less affected by electromagnetic interference.

In use, for an engagement or disengagement of the conventional optical fiber connector 1, the connector body 11 is directly held to protect the optical fiber cable 12 from damage. Recently, the connector body 11 and the optical fiber cable 12 have been developed to be miniaturized in order for the optical fiber connector 1 to be mounted in a confined space or arranged in an array. However, the miniaturization of the connector body 11 is inconvenient for a user engaging or disengaging the optical fiber connector 1.

### SUMMARY

Therefore, an object of the disclosure is to provide a sleeve for an optical fiber connector that can alleviate the drawback of the prior art.

According to the disclosure, a sleeve for an optical fiber connector is disclosed. The optical fiber connector includes an optical fiber cable, and a casing that has a main body connected to the optical fiber cable and a covering sleeved on the main body. The casing further has a projection that protrudes from the main body, and spaced-apart first and second protrusions that protrude from the covering in opposite directions. The sleeve includes a limiting unit, a first abutment structure, a second abutment structure and a grip unit.

The limiting unit includes a limiting wall and two clamping walls that extend respectively from opposite ends of the limiting wall, that are adapted for clamping the covering of the casing of the optical fiber connector, that cooperate with the limiting wall to define a clamping space adapted for accommodating the covering of the casing, and that are adapted for abutting against the second protrusion of the casing.

The first abutment structure is provided on the limiting unit, and is adapted for abutting against the projection of the casing.

The second abutment structure is provided on the limiting unit, and is adapted for abutting against the first protrusion of the casing.

The grip unit extends rearwardly from the limiting unit, is forwardly movable for driving a forward movement of the limiting unit to thereby move the casing forwardly through abutment between the first abutment structure and the projection, and is rearwardly movable for driving a rearward movement of the limiting unit to thereby move the casing rearwardly through abutment between the second abutment structure and the first protrusion and through abutment between the clamping walls and the second protrusion.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a conventional optical fiber connector;

FIG. 2 is a perspective view of a first embodiment of a sleeve for an optical fiber connector according to the disclosure that sleeves on the optical fiber connector;

FIG. 3 is a fragmentary perspective view of the optical fiber connector to be sleeved by the sleeve of the first embodiment;

FIG. 4 is a perspective view of the sleeve of the first embodiment that is separated from the optical fiber connector;

FIG. 5 is a perspective view similar to FIG. 2, but shown from a different angle to illustrate the engagement of the sleeve of the first embodiment and the optical fiber connector;

FIG. 6 is a perspective view similar to FIG. 4, but shown from a different angle to illustrate two clamping walls of the sleeve of the first embodiment;

FIG. 7 is a perspective view of a second embodiment of a sleeve for an optical fiber connector according to the disclosure;

FIG. 8 is a top view of the second embodiment, illustrating a casing of the optical fiber connector; and

FIG. 9 is perspective view illustrating engaging holes of the sleeve of the second embodiment.

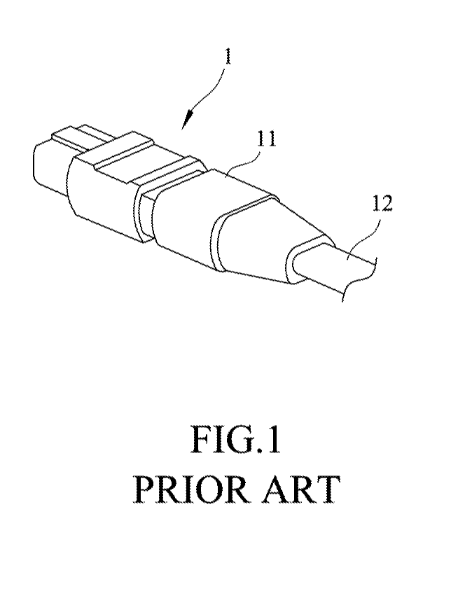

### DETAILED DESCRIPTION

Before the disclosure is described in greater detail, it should be noted that like elements are denoted by the same reference numerals throughout the disclosure.

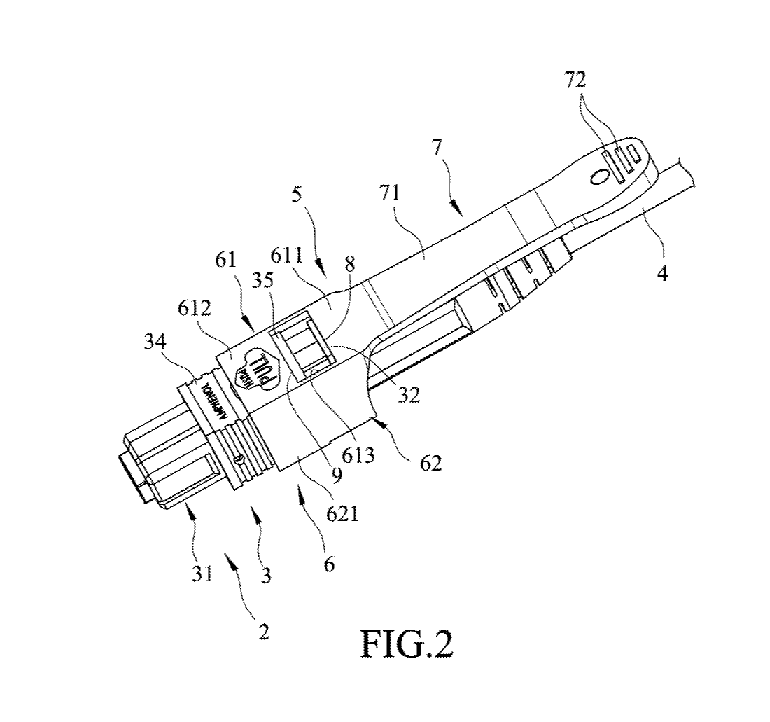

Referring to FIGS. 2 to 4, a first embodiment of a sleeve 5 for an optical fiber connector 2 according to the present disclosure in a state to sleeve on the optical fiber connector 2 and structures of the sleeve 5 and the optical fiber connector 2 are illustrated. The optical fiber connector 2 includes an optical fiber cable 4 and a casing 3.

The casing 3 has a main body 31 that has a hollow head portion 310 and a tail portion 311 connected to the optical fiber 4 opposite to the head portion 310, a covering 34 that is sleeved on the main body 31 between the head and tail portions 310, 311, at least one projection 32 that protrudes from the tail portion 311, and spaced-apart first and second protrusions 35, 36 that protrude from the covering 34 in opposite directions . In this embodiment, the at least one projection 32 protruding from the tail portion 311 are exemplified to be two projections 32, 33 that protrude from the tail portion 311 in opposite directions. The first and second protrusions 35, 36 are respectively aligned with the projections 32, 33 in a spaced-apart manner.

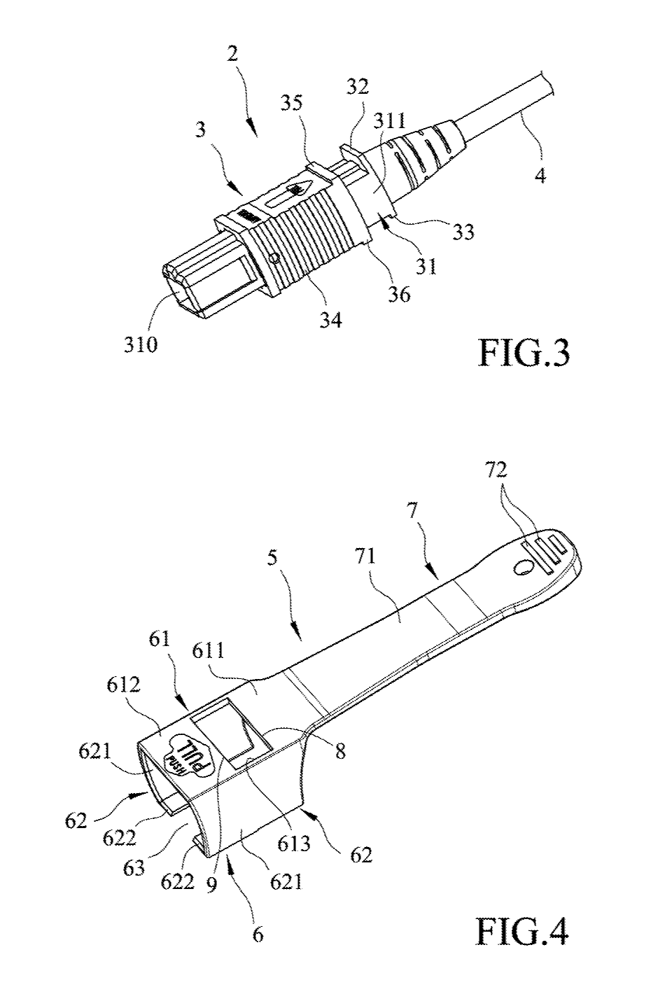

Referring to FIG. 4, in combination with FIGS. 2 and 3, the sleeve 5 includes a limiting unit 6, a first abutment structure 8 provided on the limiting unit 6, a second abutment structure 9 provided on the limiting unit 6, and a grip unit 7 extending rearwardly from the limiting unit 6. The limiting unit 6 includes a limiting wall 61 and two clamping walls 62 that extend respectively from opposite ends of the limiting wall 61, that are adapted for clamping the covering 34 of the casing 3 of the optical fiber connector 2, and that cooperate with the limiting wall 61 to define a clamping space 63 adapted for accommodating the covering 34 of the casing 3.

In this embodiment, the limiting wall 61 has a first segment 611 connected to the grip unit 7 and provided with the first abutment structure 8, a second segment 612 disposed at a front side of the first segment 611 and provided with the second abutment structure 9, and an engaging hole 613 defined between the first and second segments 611, 612. The engaging hole 613 is in spatial communication with the clamping space 63 and adapted for insertion of the projection 32 and the first protrusion 35. Specifically, the first abutment structure 8 is located at a front end of the first segment 611, and the second abutment structure 9 is located at a rear end of the second segment 612. The first and second abutment structures 8, 9 cooperatively bound the engaging hole 613 and are respectively adapted for abutting against the projection 32 and the first protrusion 35 of the casing 3 of the optical fiber 2 (see FIG. 2). The clamping walls 62 abut against the second protrusion 36 of the casing 3.

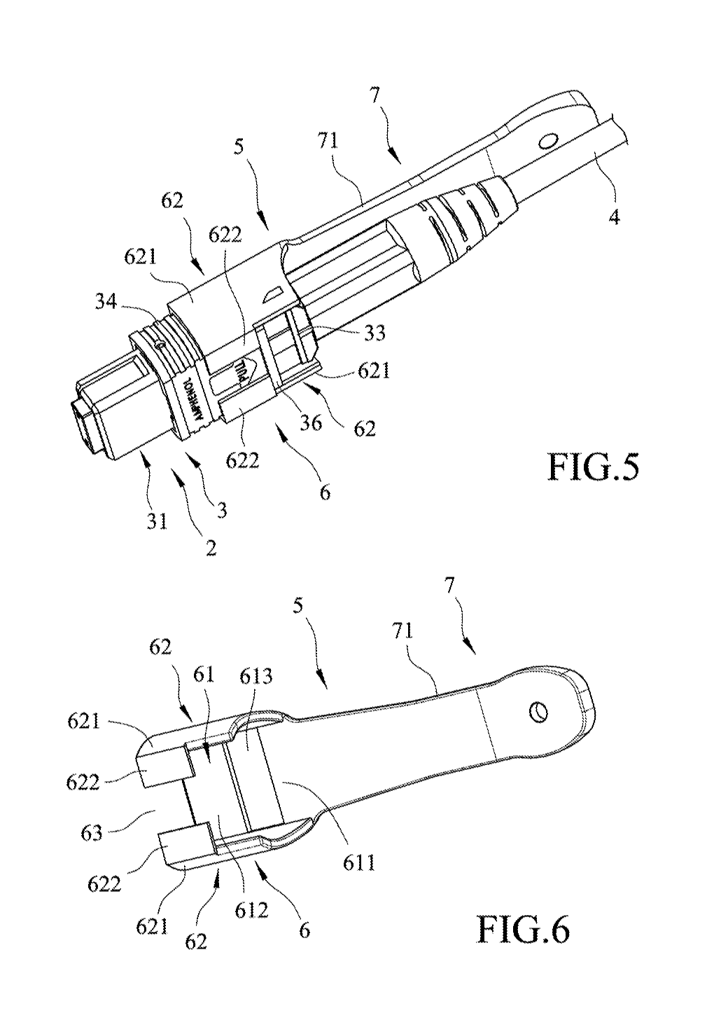

Referring to FIGS. 5 and 6, in combination with FIG. 4, the clamping walls 62 are adapted for clamping removably the covering 34 of the casing 3. Each of the clamping walls 62 has an arm portion 621 extending downwardly from a respective one of the opposite ends of the limiting wall 61 and adapted for contacting the covering 34 of the casing 3, and a hook portion 622 extending transversely from the arm portion 621 and adapted for contacting the covering 34 and abutting against the second protrusion 36 of the casing 3. In this embodiment, the arm portion 621 of each clamp wall 62 is connected integrally to the first and second segments 611, 612 of the limiting wall 61.

The grip unit 7 includes a grip 71 connected to a rear end of the first segment 611 of the limiting wall 61, and a plurality of spaced-apart anti-slip members 72 formed on the grip 71.

Referring back to FIGS. 2 and 5, by virtue of the sleeve 5 assembled with the optical fiber connector 2, when an engagement of the optical fiber connector 2 is required, a user can grasp and push forwardly the grip 71 of the grip unit 7, such that the grip unit 7 moves forwardly for driving a forward movement of the limiting unit 6 to thereby move the casing 3 forwardly through abutment between the first abutment structure 8 at the front end of the first segment 611 and the projection 32. When a disengagement of the optical fiber connector 2 is required, the user can grasp and pull rearwardly the grip 71 of the grip unit 7, such that the grip unit 7 moves rearwardly for driving a rearward movement of the limiting unit 6 to thereby move the casing 3 rearwardly through abutment between the second abutment structure 9 at the rear end of the second segment 612 and the first protrusion 35 and through abutment between the hook portions 622 of the clamping walls 62 and the second protrusion 36.

It should be noted that, in this embodiment, the projections 32, 33 are exemplified to be symmetrically spaced apart from each other relative to the main body 31 of the casing 3, and the first and second protrusions 35, 36 are exemplified to be symmetrically spaced apart from each other relative to the covering 34 and to be respectively aligned with the projections 32, 33. The casing 3 is rotatable without limitation caused by the projections 32, 33 and the first and second protrusions 35, 36 when the sleeve 5 of the disclosure is assembled with the optical fiber connector 2. In other words, the engaging hole 613 can allow insertion of the projection 33 and the second protrusion 36, and the hook portions 622 of the clamping walls 62 can abut against the first protrusion 35. In such a manner, the user can assemble the sleeve 5 with the optical fiber 2 without the limitations of the projections 32, 33 and the first and second protrusions 35, 36, thereby saving assembling time. Alternatively, in some embodiments, the projection 33 may be omitted from the casing 3.

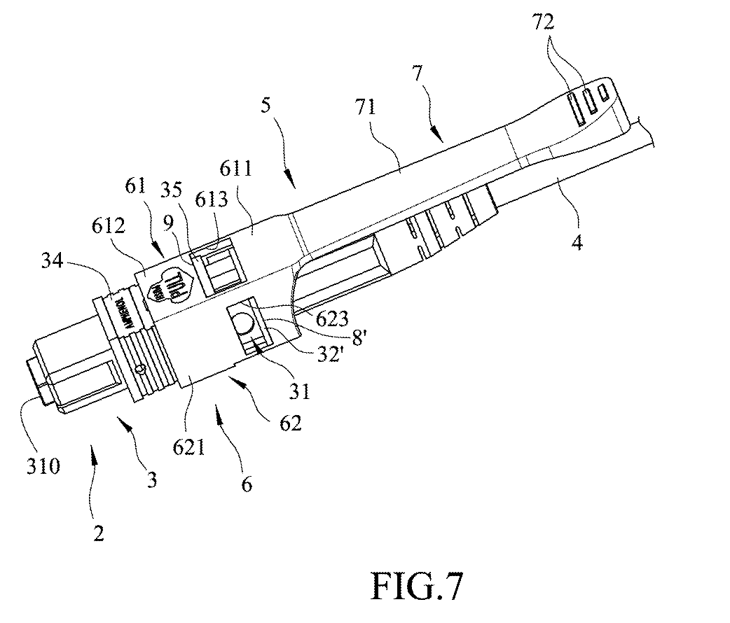

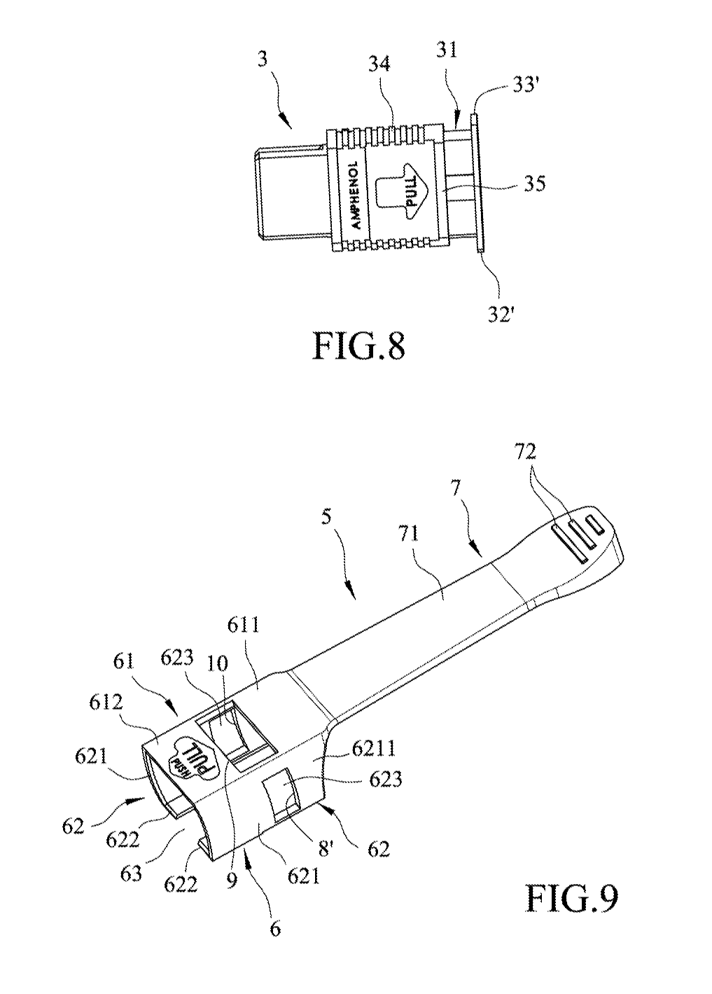

FIGS. 7 to 9 illustrate a second embodiment of a sleeve 5 of the disclosure, which is generally similar to the first embodiment. The differences between the first and second embodiment reside in the structural arrangements of the casing 3 of the optical fiber connector 2 and the limiting unit 6 of the sleeve 5.

In this embodiment, the casing 3 has the projections 32′, 33′ protruding from the main body 31 opposite to each other in a direction transverse to a direction in which the first and second protrusions 35, 36 protrude oppositely to each other relative to the main body 31. The sleeve 5 further includes a third abutment structure 10 provided on the limiting unit 6. Particularly, the arm portion 621 of each of the clamping walls 62 has a first section 6211, a second section 6212 disposed at a front side of the first section 6211, and a second engaging hole 623 defined between the first and second sections 6211, 6212 in spatial communication with the clamping space 63 for insertion of a respective one of the prof ections 32′ , 33′. A front end of the first section 6211 of the arm portion 621 of one of the clamping walls 62 is provided with the first abutment structure 8′ for abutting against one of the projections 32′, 33′ through the second engaging hole 623 of the one of the clamping walls 62. A front end of the first section 6211 of the arm portion 621 of the other one of the clamping walls 62 is provided with the third abutment structure 10 for abutting against the other one of the projections 32′, 33′ through the second engaging hole 623 of the other one of the clamping walls 62. When the sleeve 5 is assembled with the optical fiber connector 2, the second abutment structure 9 is facingly adjacent to the first protrusion 35 of the casing 3 of the optical fiber connector 2 through the first engaging hole 613, the first and third abutment structures 8′, 10 of the limiting unit 6 are respectively and facingly adjacent to the projections 32, 33 through the second engaging holes 623 of the clamping walls 62, and rear ends of the hook portions 622 of the clamping walls 62 are adjacent to the second protrusion 36.

When an engagement of the optical fiber connector 2 is required, a user can grasp and push forwardly the grip 71 of the grip unit 7, such that the first and third structure abutments 8′, 10 on the arm portion 621 of the clamping walls 62 respectively abut against the projections 32′, 33′ to thereby move forwardly the casing 3. When a disengagement of the optical fiber connector 2 is required, the user can grasp and pull rearwardly the grip 71 of the grip unit 7, such that the second abutment structure 9 on the first segment 612 of the limiting wall 61 abuts against the first protrusion 35 and the rear ends of the hook portions 622 of the clamping walls 62 abut against the second protrusion 36 to thereby move rearwardly the casing 3.

To sum up, by virtue of the anti-slip members 72 formed on the grip 71 and the first and second abutment structures provided on the limiting unit 6, the user can easily use the sleeve 5 of the disclosure to move the casing 3 for the engagement or disengagement of the optical fiber connector 2 in a confined space where the optical fiber connector 2 cannot be conveniently held.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A sleeve for an optical fiber connector, the optical fiber connector including an optical fiber cable, and a casing that has a main body connected to the optical fiber cable and a covering sleeved on the main body, the casing further having a projection that protrudes from the main body, and spaced-apart first and second protrusions that protrude from the covering in opposite directions, said sleeve comprising:
a limiting unit including
a limiting wall, and
two clamping walls that extend respectively from opposite ends of said limiting wall, that are adapted for clamping the covering of the casing of the optical fiber connector, that cooperate with said limiting wall to define a clamping space adapted for accommodating the covering of the casing, and that are adapted for abutting against the second protrusion of the casing;
a first abutment structure provided on said limiting unit, and adapted for abutting against the projection of the casing;
a second abutment structure provided on said limiting unit, and adapted for abutting against the first protrusion of the casing; and
a grip unit extending rearwardly from said limiting unit, forwardly movable for driving a forward movement of said limiting unit to thereby move the casing forwardly through abutment between said first abutment structure and the projection, and rearwardly movable for driving a rearward movement of said limiting unit to thereby move the casing rearwardly through abutment between said second abutment structure and the first protrusion and through abutment between said clamping walls and the second protrusion.

2. The sleeve as claimed in claim 1, wherein said limiting wall has:
a first segment connected to said grip unit and provided with said first abutment structure;
a second segment disposed at a front side of said first segment and provided with said second abutment structure; and
an engaging hole defined between said first and second segments, being in spatial communication with said clamping space, and adapted for insertion of the projection and the first protrusion.

3. The sleeve as claimed in claim 1, wherein:
said clamping walls are adapted for clamping removably the covering of the casing; and
each of said clamping walls has an arm portion extending downwardly from a respective one of said opposite ends of said limiting wall, and a hook portion extending transversely from said arm portion, and adapted for abutting against the second protrusion of the casing.

4. The sleeve as claimed in claim 3, wherein said grip unit includes a grip connected to a rear end of said first segment of said wall, and a plurality of anti-slip members formed on said grip.

5. The sleeve as claimed in claim 1, wherein:
said limiting wall has
a first segment connected to said grip unit,
a second segment disposed at a front side of said first segment and provided with said second abutment structure, and
a first engaging hole defined between said first and second segments, being in spatial communication with said clamping space, and adapted for insertion of the first protrusion; and
one of said clamping walls has
a first section provided with said first abutment structure,
a second section disposed at a front side of said first section, and
a second engaging hole defined between said first and second sections, being in spatial communication with said clamping space, and adapted for insertion of the projection.
